(19) United States
(12) Patent Application Publication
(10) Pub. No.: US 2015/0116818 A1
(43) Pub. Date: Apr. 30, 2015

(54) INFRARED ZOOM LENS

(71) Applicant: TAMRON CO., LTD, Saitama-shi, Saitama (JP)

(72) Inventor: Minoru Ando, Saitama-shi (JP)

(73) Assignee: TAMRON CO., LTD, Saitama-shi, Saitama (JP)

(21) Appl. No.: 14/395,569

(22) PCT Filed: Apr. 22, 2013
(86) PCT No.: PCT/JP2013/061760

§ 371 Date: Oct. 20, 2014

(30) Foreign Application Priority Data
Apr. 20, 2012 (JP) 2012-096844

(51) Int. Cl. G02B 15/177; G02B 13/18; G02B 13/04; G02B 13/14

(52) U.S. Cl. CPC G02B 15/177; G02B 13/14; G02B 13/18; G02B 13/04
USPC 359/354

(57) ABSTRACT

Provided is a zoom lens that has a four-lens configuration and is capable of having a viewing angle of larger than 180°. Provided is an infrared zoom lens that has a long back focus. The present invention comprises a first lens group that has a negative refractive power, and a second lens group that has a positive refractive power. During zooming, the first lens group and the second lens group move on an optical axis, and each of the first lens group and the second lens group is configured of two single lenses.

### FIELD OF THE INVENTION

The present invention relates to infrared zoom lenses, and more particularly, to wider viewing angle infrared zoom lenses that pass infrared beams ranging from 8 μm to 14 μm and are available as monitor camera optics for surveillance in the darkness against trespassers or as devices of determining temperature distribution.

### BACKGROUND ART

It is critical for monitor cameras to cover a wider field of view for efficient surveillance. In addition, it has been strongly desired that their infrared optical systems are reduced in the number of component infrared lens pieces since materials for them are expensive and are reduced in loss of light due to surface reflection from component lens pieces.

One typical example of the prior art infrared lenses supposed so far is that which has an angle of field as wide as 112° and is of mono-focal scheme where there are an objective lens group serving to produce an intermediate image and a relay lens group RL refracting the intermediate image for re-imaging on an infrared detector 1, and the objective lens group is comprised of four component lens pieces, namely, the foremost or first concave meniscus lens L1, the succeeding or second concave lens L2, the third convex lens L3, and the rearmost or fourth convex lens L4 disposed serially in this order relative to an object while the relay lens group RL includes the foremost or fifth convex meniscus lens L5, the succeeding or sixth concave lens L6, the seventh convex lens L7, and the rearmost or eighth convex lens L8 also disposed serially in this order relative to the object, eight of the lens pieces being made of two kinds of infrared-transparent material, the second and sixth lenses L2, L6 being of a greater amount of the infrared-transparent material than the first, third to fifth, and seventh to ninth lenses, a cooled aperture stop is placed between the eighth lens and the re-imaging plane, and the infrared lens meeting predetermined mathematical expressions (see Patent Document 1 listed below).

Another typical example of the prior art infrared lenses is that which is reduced in the number of component lens pieces and has all of its lens pieces made of materials containing zinc sulfide so as to attain a compact and cost-reduced infrared zoom lens where there are three of the lens groups, namely, the first to third ones serially disposed on closer to an object first basis, and during the zooming, the first and third lens groups keep stationary while the second lens group alone is moved, the first to third lens groups respectively include at least one lens piece made of zinc sulfide (e.g., see Patent Document 2 listed below).

Still another typical example of the prior art infrared lenses supposed so far is that which has a back focal distance defined as long as a focal length or even longer to ensure a sufficient length for the optical system and simultaneously reaches a compromise solution to satisfactory ambient-ray performance and moderate dimensional reduction to have the desired 100% vignetting factor guaranteed. Such an infrared zoom lens comprises a first lens group G1 of negative refractivity and a second lens group G2 of positive refractivity where the first lens group G1 has a first lens L1 formed in negative meniscus lens with its convex surface faced toward an object and a second lens L2 of positive refractivity while the second lens group G2 has a third lens L3 formed in positive meniscus lens with its convex surface faced toward an imaging plane and a fourth lens L4 formed in positive meniscus lens with its convex surface faced toward the object, and the infrared zoom lens is adapted to meet predetermined conditions (e.g., see Patent Document 3 listed below).

### LIST OF DOCUMENTS OF THE RELATED ART

### Patent Documents

Patent Document 1
JP Preliminary Publication of Unexamined Pat. Appl. No. H04-356008
Patent Document 2
JP Patent No. 3982554
Patent Document 3
JP Preliminary Publication of Unexamined Pat. Appl. No. 2005-173346

The infrared lens disclosed in Patent Document 1, which is of non-zoom 8-lens structure, has disadvantages of loss of light due to surface reflection from or absorption into lens pieces and increased manufacturing cost. In addition, its mono-focal scheme leads to a poor manipulability in comparison with zoom lenses, and especially, when used in surveillance cameras, the infrared lens still lets users encounter an unsolved inconvenience of the angle of field as narrow as 112°.

The infrared zoom lens disclosed in Patent Document 2, which is of non-composite 4-lens structure, is capable of suppressing loss of light due to surface reflection from or absorption into lens pieces as well as increase in the manufacturing cost. However, its maximal angle of field of approximately 20° is extremely small, and especially, when used in surveillance cameras, the infrared lens is conspicuously disadvantageous.

The macro lens disclosed in Patent Document 3 has a mono-focal scheme leading to a poor manipulability in comparison with zoom lenses, and when used in surveillance cameras, the macro lens lets users experience an unsolved inconvenience of the angle of field as narrow as 40° or even smaller.

The present invention is made allowing for the aforementioned problems in the prior art infrared lenses, and accordingly, it is an object of the present invention to provide an improved infrared lens that is a zoom lens of 4-lens structure and is capable of attaining an angle of field as wide as 180° or even greater.

It is another object of the present invention to provide an infrared zoom lens having a long back focal distance.

### SUMMARY OF THE INVENTION

In accordance with the present invention, an infrared zoom lens comprises a front or first lens group of negative refractive power and a rear or second lens group of positive refractive power and is adapted to axially displace the first and second lens groups during varying the refractive power.

Each of the first and second lens groups is of two non-composite or non-cemented lens pieces.

The infrared zoom lens according to the present invention is of 4-lens structure and capable of attaining an angle of field as wide as 180° or even greater. Additionally, the infrared zoom lens has a long back focal distance to increase manipulability for user's convenience.

### Embodiment 1

In one aspect of the aforementioned present invention, the infrared zoom lens meets the requirements defined as follows:

−4.7<f1/fw<−2.2 (1)

where f1 is a focal length of the first lens group, and fw is a focal length of the entire lens system at the wide viewing angle.

The formula (1) expresses conditions to keep curvature of field acceptable at the wide viewing angle. When a value of f1/fw deviates from both the upper and lower limits defined in the formula (1), the infrared zoom lens develops curvature of field and fails to achieve desirable resolution. When the value is lower than the lower limit defined in formula (1), the infrared zoom lens has its back focal distance so reduced as to fail to incorporate required optical elements such as a shutter mechanism, resulting in degradation of the sensing precision of a measuring device in which the infrared zoom lens is incorporated.

### Embodiment 2

In another aspect of the present invention, the infrared zoom lens meets the requirements as follows:

2.0<f2/fw<4.0 (2)

where f2 is a focal length of the second lens group, and fw is a focal length of the entire lens system at the wide viewing angle.

The formula (2) expresses conditions to suppress spherical aberration. When a value of f2/fw is lower than the lower limit defined in formula (2), the infrared zoom lens develops a positive spherical aberration relative to the paraxial focus and fails to ensure sufficient resolution. Reversely, when the value exceeds the upper limit, the infrared zoom lens develops a negative spherical aberration relative to the paraxial focus.

### Embodiment 3

In still another aspect of the present invention, the first lens group comprises a negative meniscus lens closer to an object and a positive meniscus lens closer to an imaging plane.

The first lens group is adapted to suppress distortion, curvature of field, and chromatic aberration developed at the wide viewing angle. The front lens piece (closer to the object) of the first lens group has its front side shaped in convex surface, and this permits beams incident on the front side of the front lens piece to enter at a reduced angle, which in turn is effective in reducing distortion aberration. The rear lens piece (closer to the imaging plane) of the first lens group is formed in positive meniscus lens, having its rear side shaped in convex surface, and this is effective in suppressing chromatic aberration developed in the first lens group and reducing curvature of field.

### Embodiment 4

In further another aspect of the present invention, at least one of the lens pieces in the second lens group has its one or opposite sides shaped in aspheric surface.

With the front lens piece (closer to the object) of the second lens group having its one or opposite sides shaped in aspheric surface, the infrared zoom lens can suppress spherical aberration and achieve a satisfactory resolution. Moreover, with the rear lens piece (closer to the imaging plane) of the second lens group having its one or opposite sides shaped in aspheric surface, the infrared zoom lens can reduce curvature of field.

### Embodiment 5

In still more another aspect of the present invention, the lens pieces in both the first and second lens groups are made of germanium.

The lens pieces, formed in this manner, can have their respective thicknesswise dimensions reduced, which in turn is effective in suppressing loss of light due to absorption into the lens medium.

### BRIEF DESCRIPTION OF THE DRAWINGS

FIG. 1 is a vertical sectional view of a first embodiment of an infrared zoom lens according to the present invention, illustrating groups of lens pieces displaced from their respective infinity focus positions to the wide angle end positions;

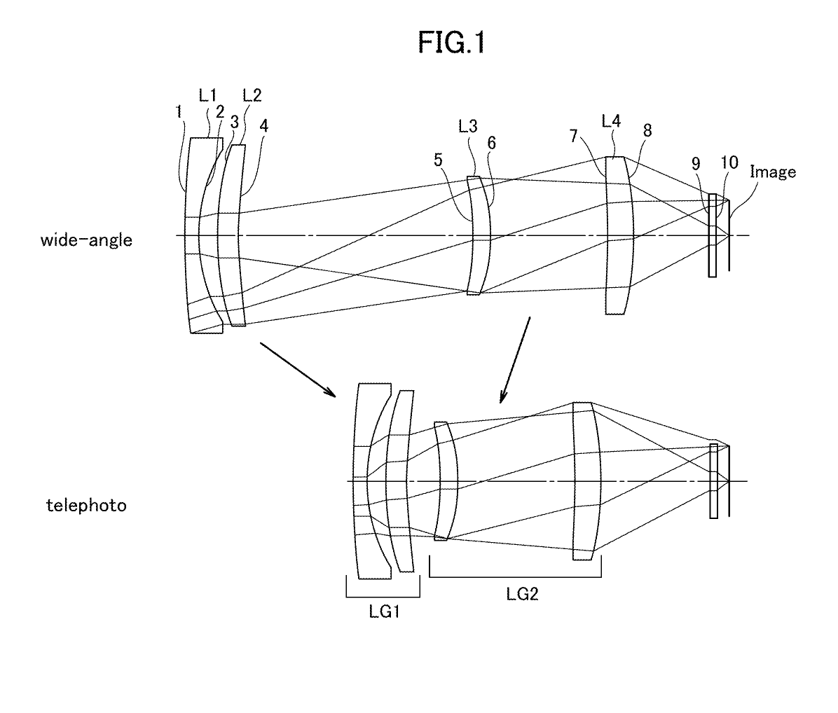

FIG. 2 depicts graphs of various types of aberration developed in the first embodiment of the infrared zoom lens in infinity focus at wide-angle end regarding beams of wavelength of 10 μm, including the graphs of spherical aberration (a), astigmatism (b), and distortion (c);

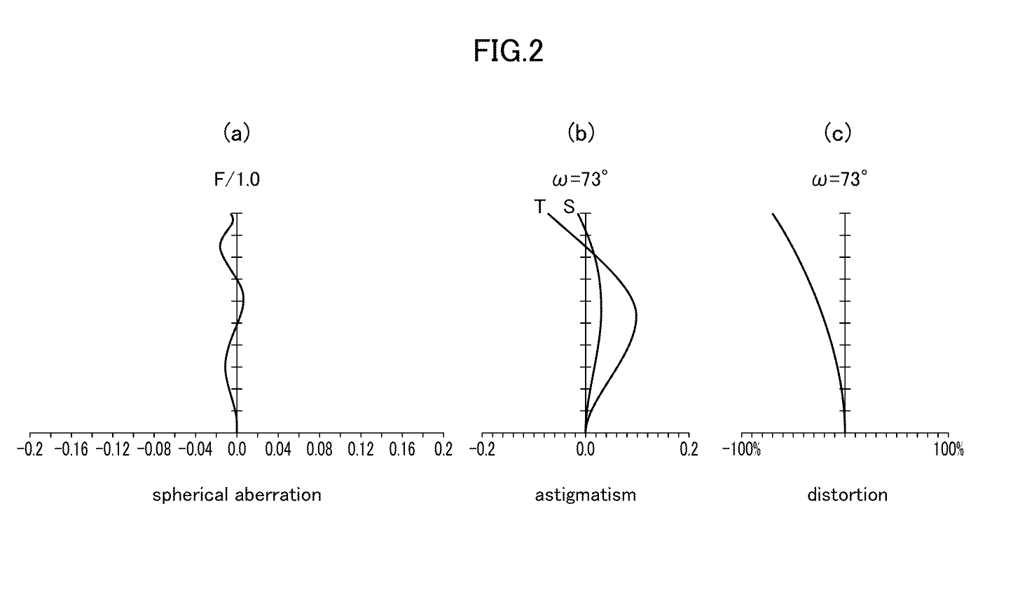

FIG. 3 depicts graphs of various types of aberration developed in the first embodiment of the infrared zoom lens in infinity focus at telephotographing end regarding beams of wavelength of 10 μm, including the graphs of spherical aberration (a), astigmatism (b), and distortion (c);

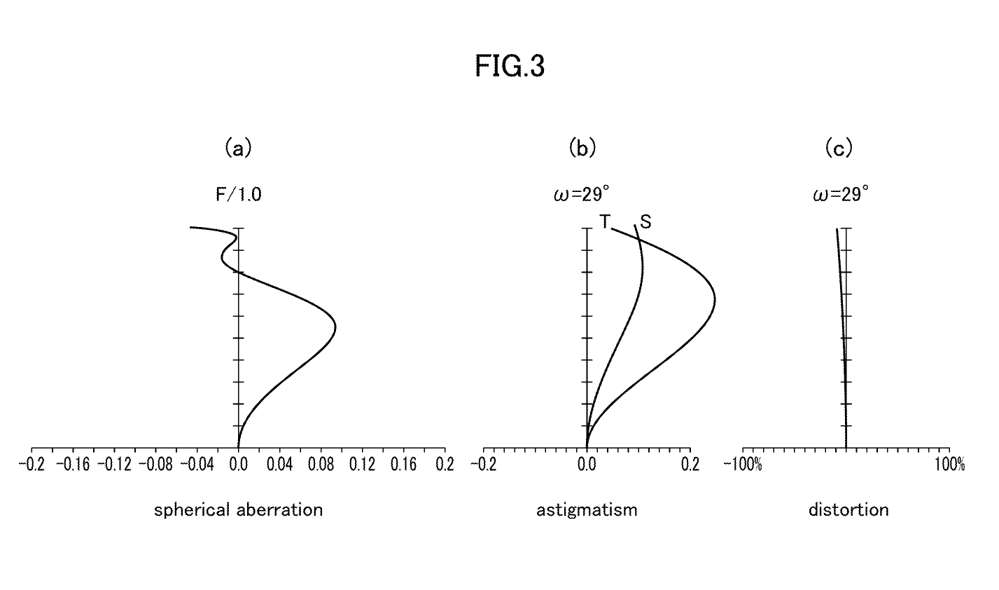

FIG. 4 is a vertical sectional view of a second embodiment of the infrared zoom lens according to the present invention, illustrating groups of lens pieces displaced from their respective infinity focus positions to the wide angle end positions;

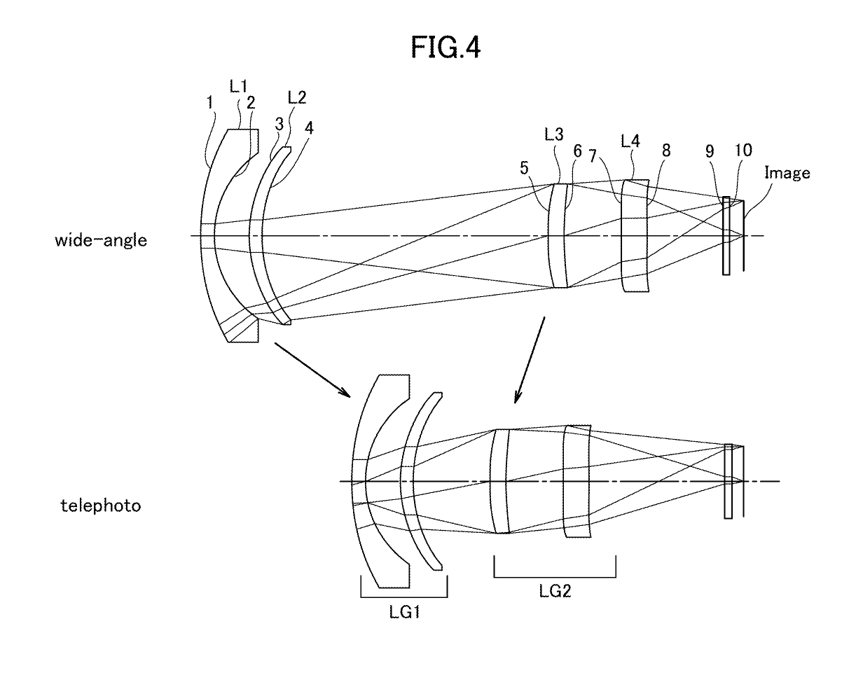

FIG. 5 depicts graphs of various types of aberration developed in the second embodiment of the infrared zoom lens in infinity focus at wide-angle end regarding beams of wavelength of 10 μm, including the graphs of spherical aberration (a), astigmatism (b), and distortion (c);

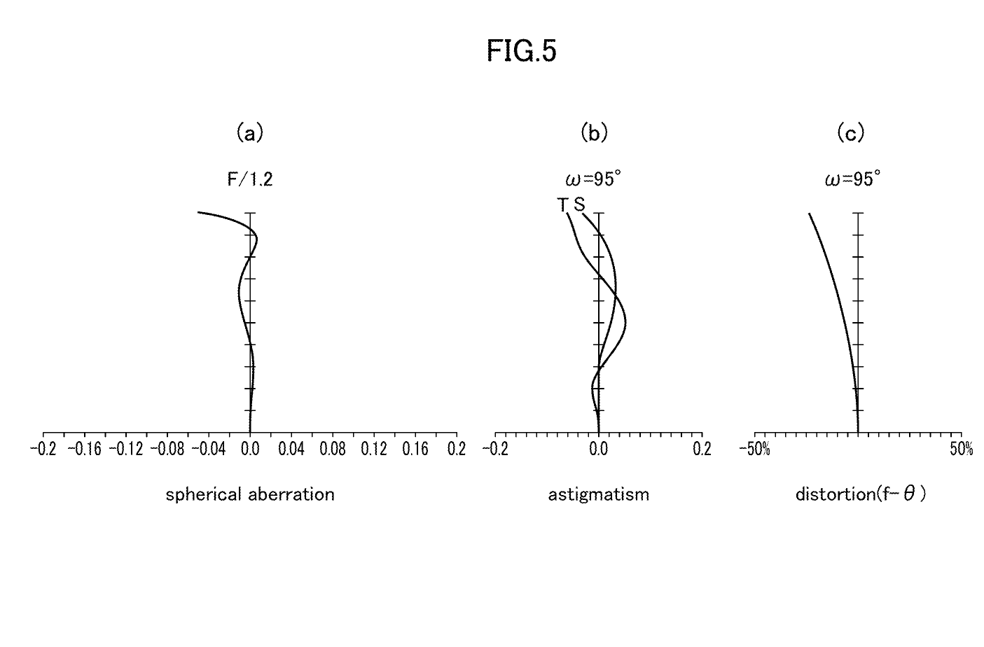

FIG. 6 depicts graphs of various types of aberration developed in the second embodiment of the infrared zoom lens in infinity focus at telephotographing end regarding beams of wavelength of 10 μm, including the graphs of spherical aberration (a), astigmatism (b), and distortion (c);

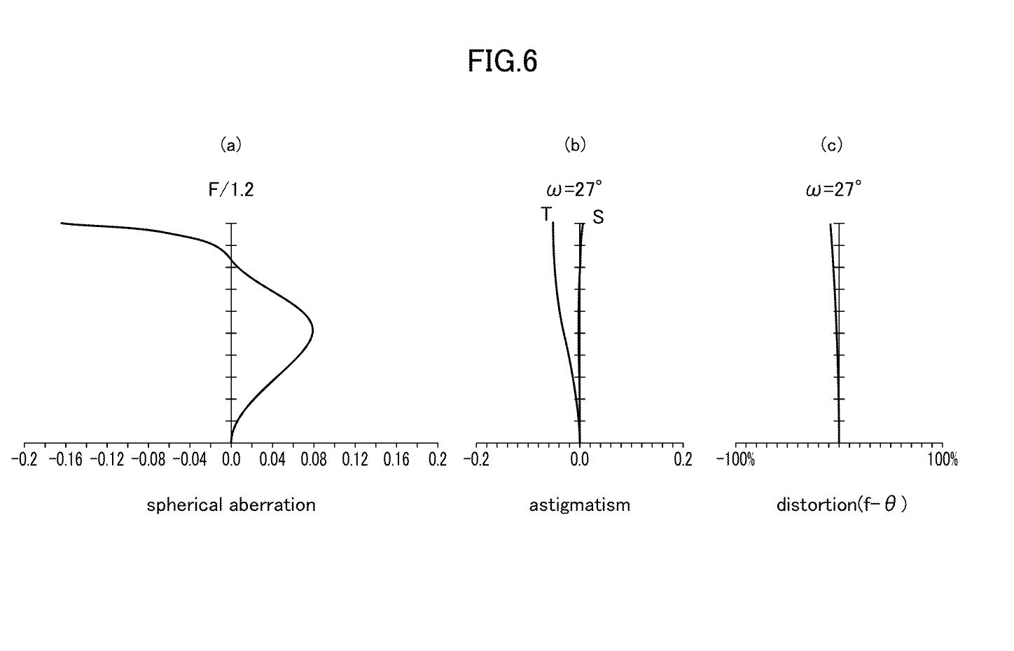

FIG. 7 is a vertical sectional view of a third embodiment of the infrared zoom lens according to the present invention, illustrating groups of lens pieces displaced from their respective infinity focus positions to the wide angle end positions;

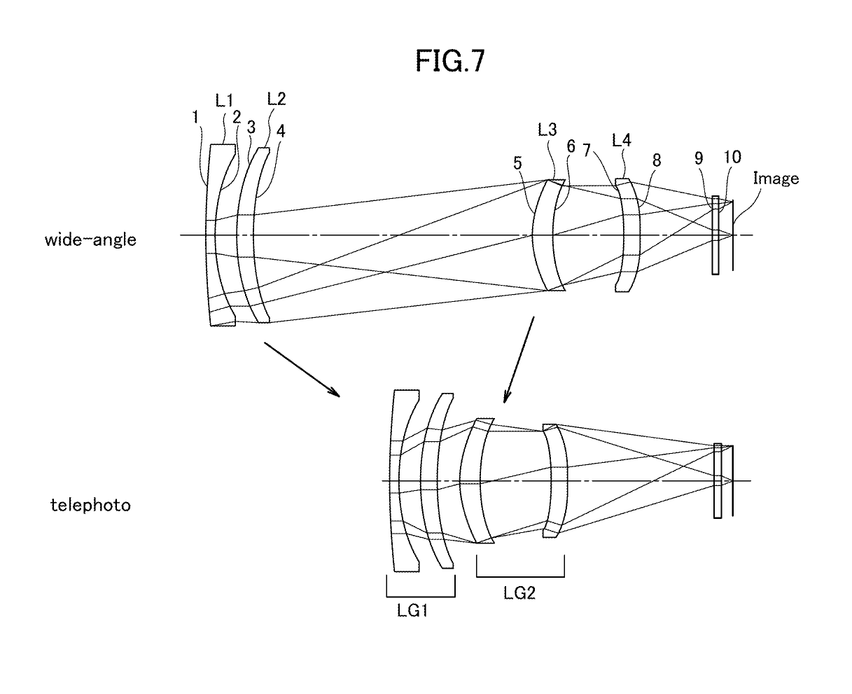

FIG. 8 depicts graphs of various types of aberration developed in the third embodiment of the infrared zoom lens in infinity focus at wide-angle end regarding beams of wavelength of 10 μm, including the graphs of spherical aberration (a), astigmatism (b), and distortion (c);

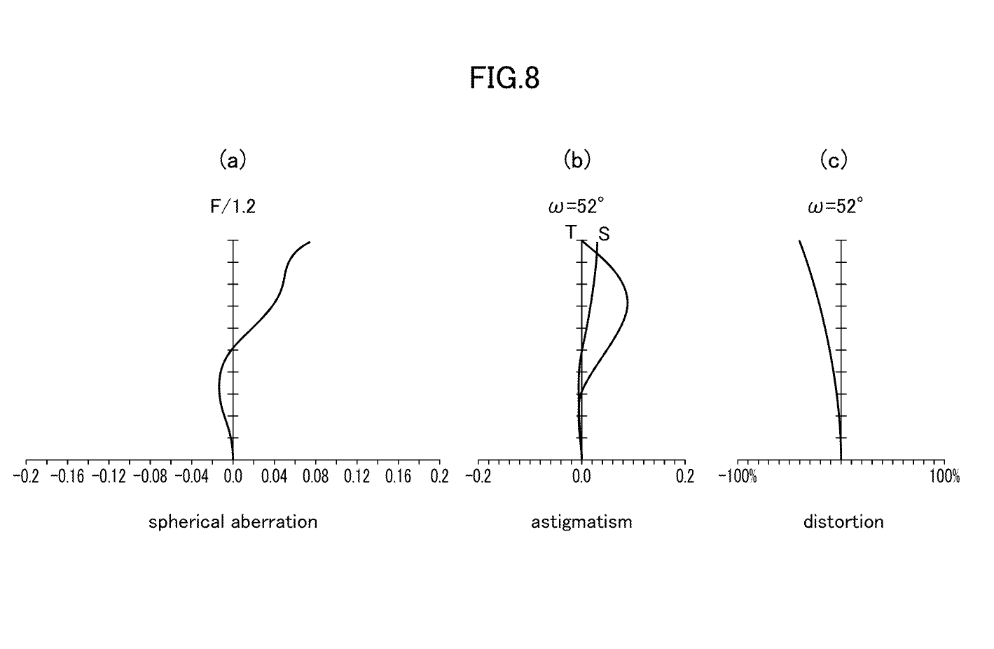

FIG. 9 depicts graphs of various types of aberration developed in the third embodiment of the infrared zoom lens in infinity focus at telephotographing end regarding beams of wavelength of 10 μm, including the graphs of spherical aberration (a), astigmatism (b), and distortion (c);

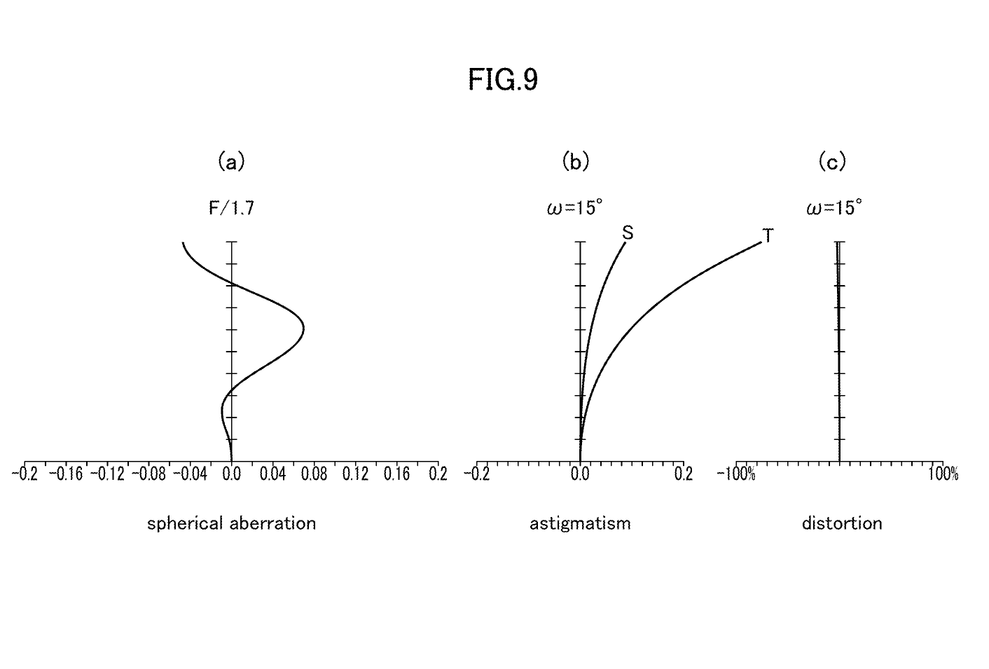

FIG. 10 is a vertical sectional view of a fourth embodiment of the infrared zoom lens according to the present invention, illustrating groups of lens pieces displaced from their respective infinity focus positions to the wide angle end positions;

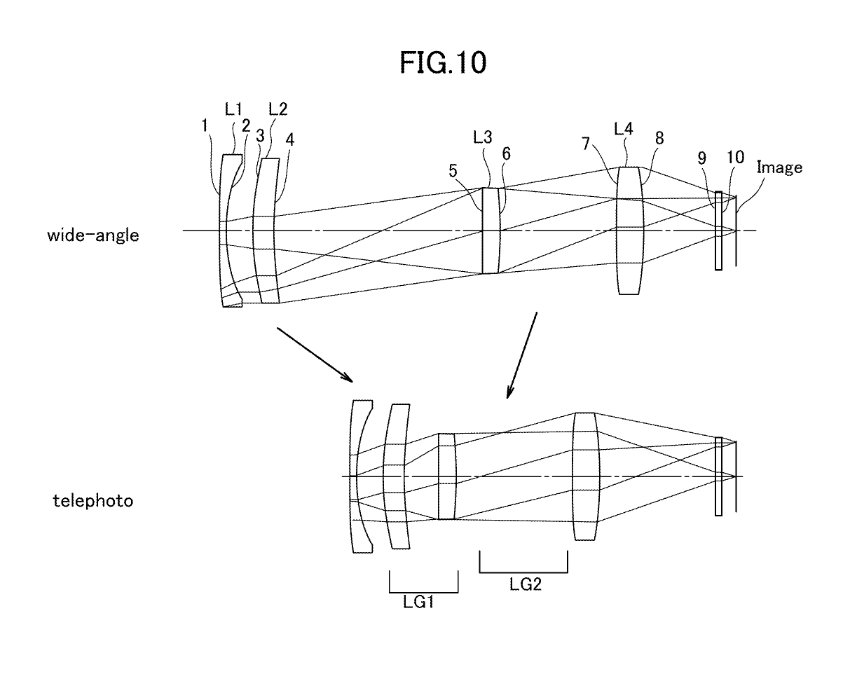

FIG. 11 depicts graphs of various types of aberration developed in the fourth embodiment of the infrared zoom lens in infinity focus at wide-angle end regarding beams of wavelength of 10 μm, including the graphs of spherical aberration (a), astigmatism (b), and distortion (c);

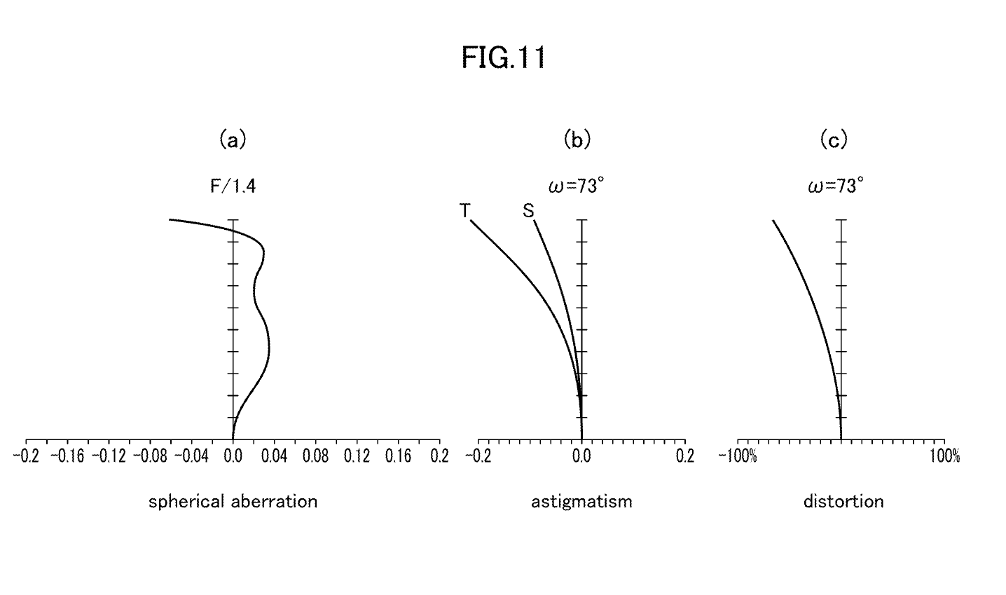

FIG. 12 depicts graphs of various types of aberration developed in the fourth embodiment of the infrared zoom lens in infinity focus at telephotographing end regarding beams of wavelength of 10 μm, including the graphs of spherical aberration (a), astigmatism (b), and distortion (c);

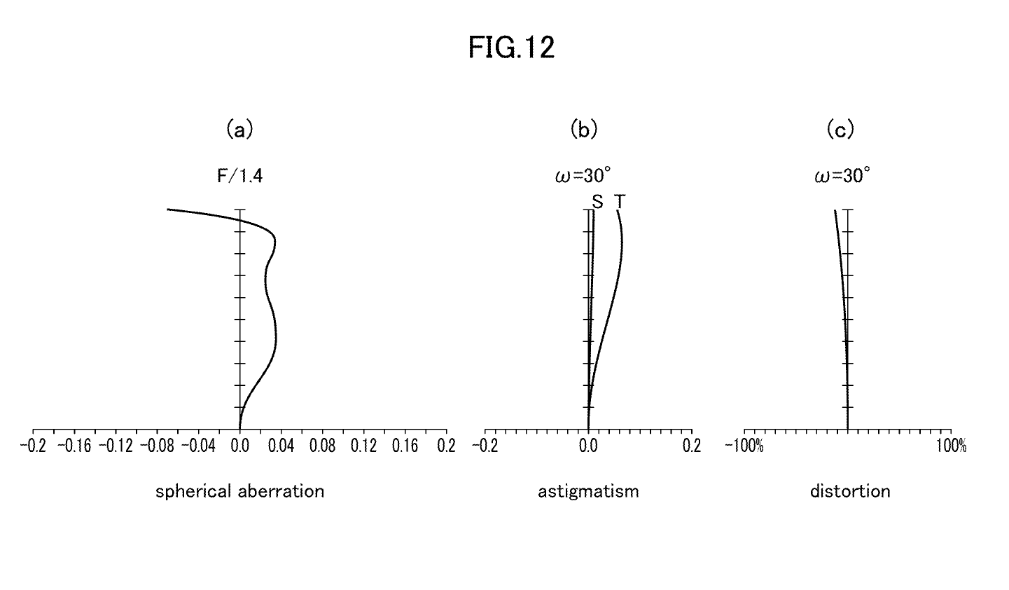

FIG. 13 is a vertical sectional view of a fifth embodiment of the infrared zoom lens according to the present invention, illustrating groups of lens pieces displaced from their respective infinity focus positions to the wide angle end positions;

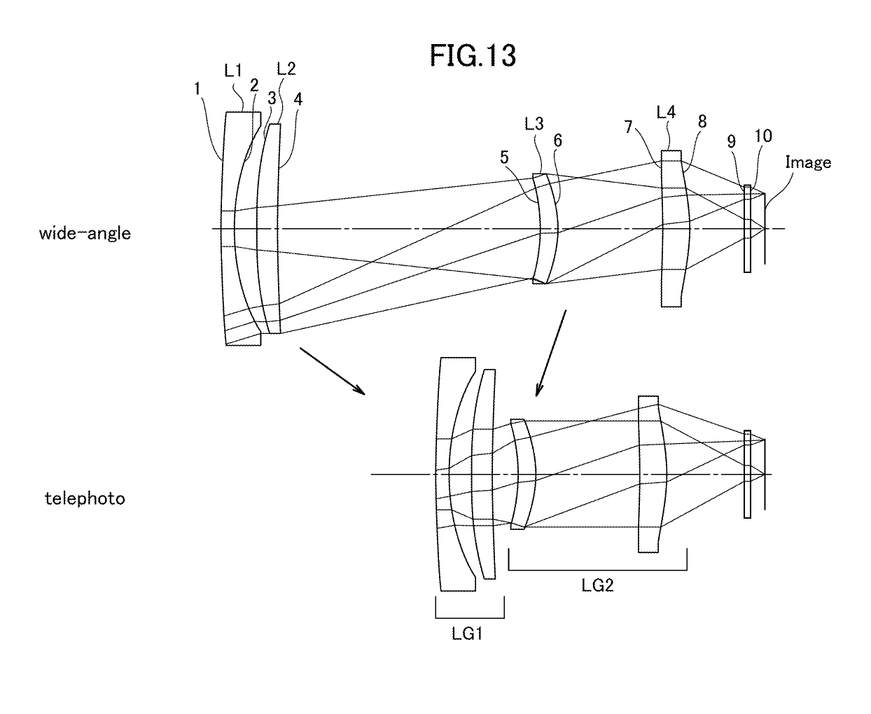

FIG. 14 depicts graphs of various types of aberration developed in the fifth embodiment of the infrared zoom lens in infinity focus at wide-angle end regarding beams of wavelength of 10 μm, including the graphs of spherical aberration (a), astigmatism (b), and distortion (c);

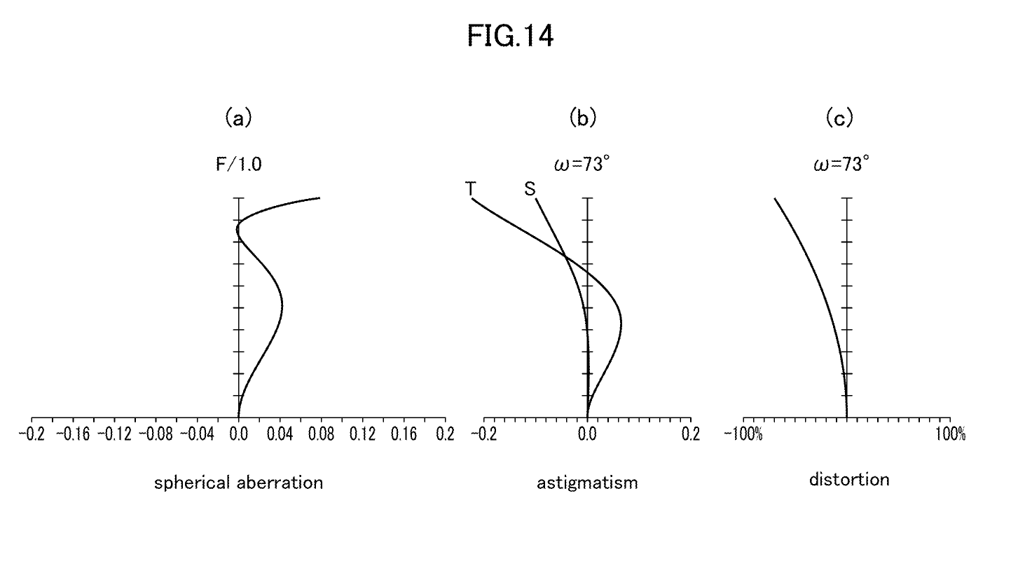

FIG. 15 depicts graphs of various types of aberration developed in the fifth embodiment of the infrared zoom lens in infinity focus at telephotographing end regarding beams of wavelength of 10 μm, including the graphs of spherical aberration (a), astigmatism (b), and distortion (c);

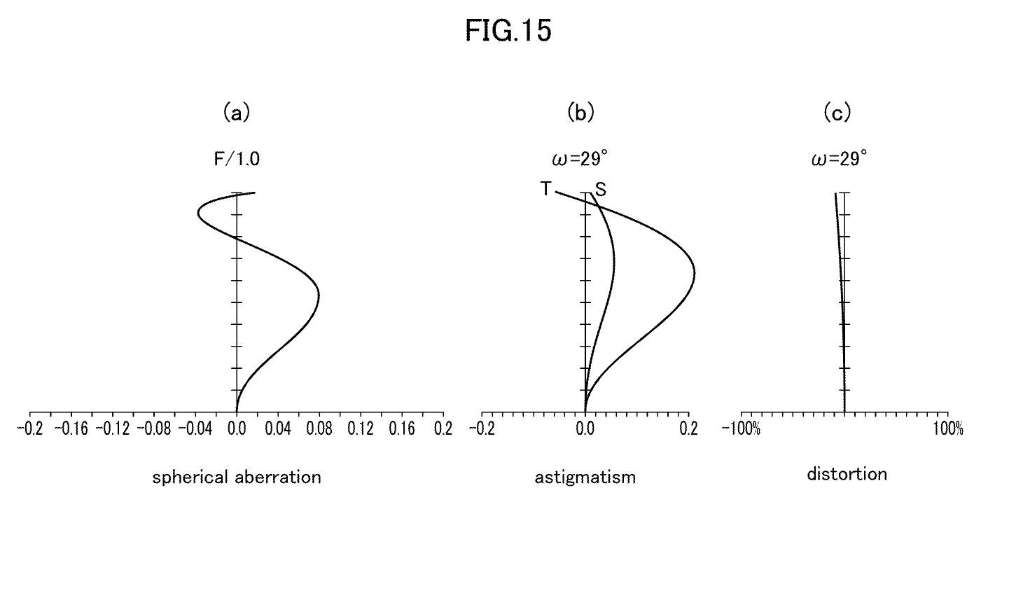

FIG. 16 is a vertical sectional view of a sixth embodiment of the infrared zoom lens according to the present invention, illustrating groups of lens pieces displaced from their respective infinity focus positions to the wide angle end positions;

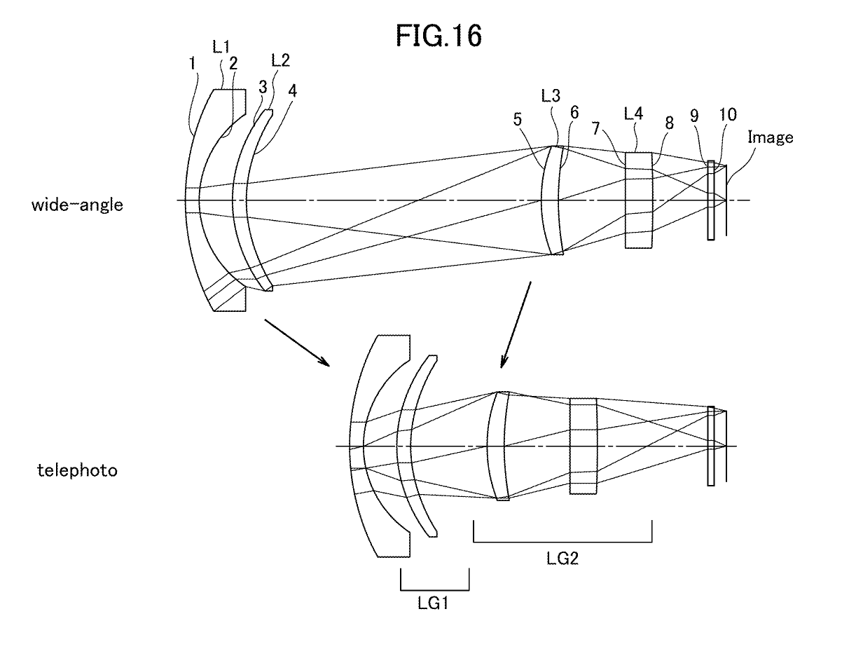

FIG. 17 depicts graphs of various types of aberration developed in the sixth embodiment of the infrared zoom lens in infinity focus at wide-angle end regarding beams of wavelength of 10 μm, including the graphs of spherical aberration (a), astigmatism (b), and distortion (c);

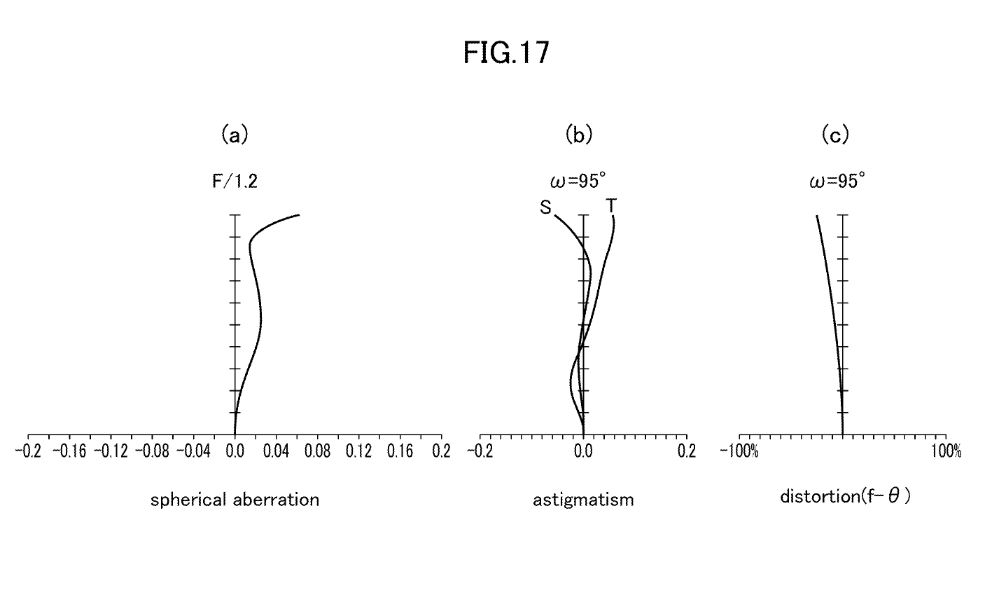

FIG. 18 depicts graphs of various types of aberration developed in the sixth embodiment of the infrared zoom lens in infinity focus at telephotographing end regarding beams of wavelength of 10 μm, including the graphs of spherical aberration (a), astigmatism (b), and distortion (c);

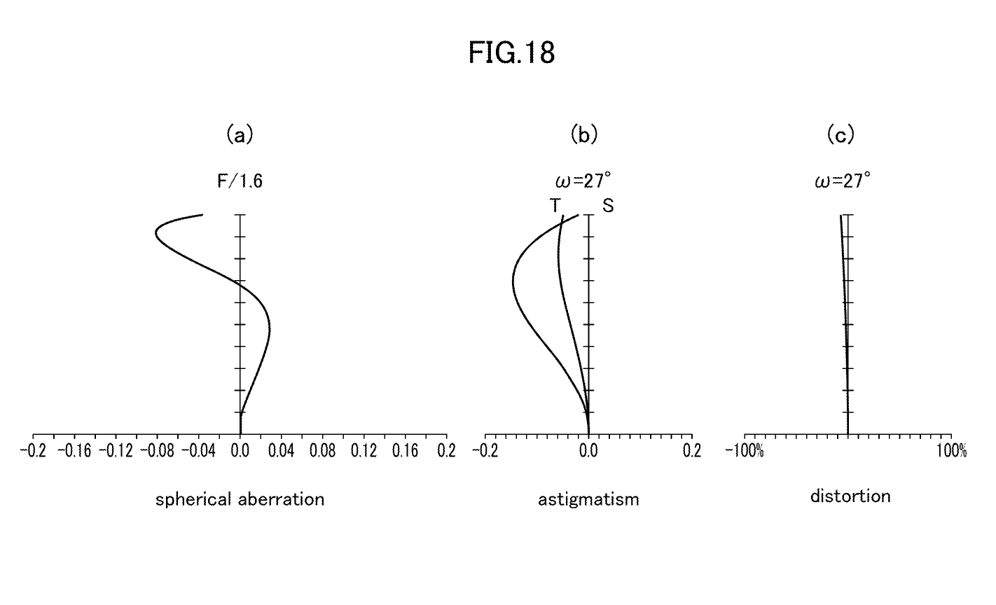

FIG. 19 is a vertical sectional view of a seventh embodiment of the infrared zoom lens according to the present invention, illustrating groups of lens pieces displaced from their respective infinity focus positions to the wide angle end positions;

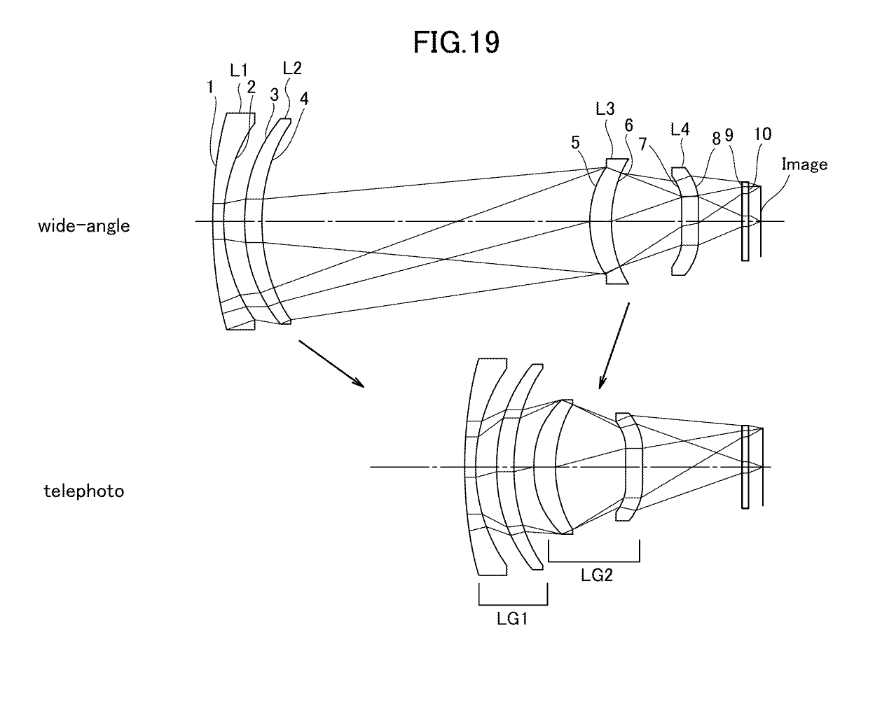

FIG. 20 depicts graphs of various types of aberration developed in the seventh embodiment of the infrared zoom lens in infinity focus at wide-angle end regarding beams of wavelength of 10 μm, including the graphs of spherical aberration (a), astigmatism (b), and distortion (c);

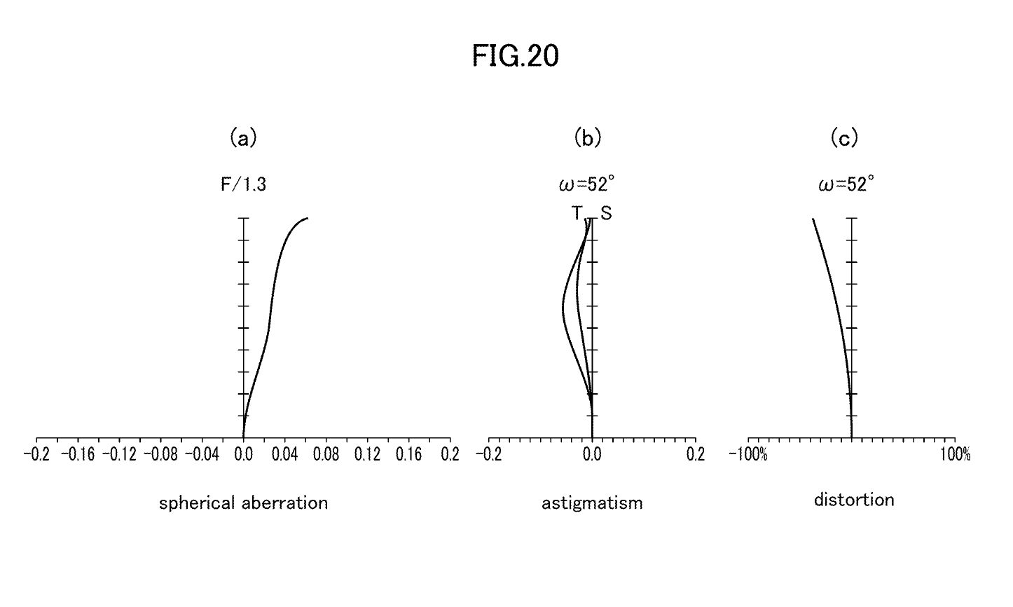

FIG. 21 depicts graphs of various types of aberration developed in the seventh embodiment of the infrared zoom lens in infinity focus at telephotographing end regarding beams of wavelength of 10 μm, including the graphs of spherical aberration (a), astigmatism (b), and distortion (c);

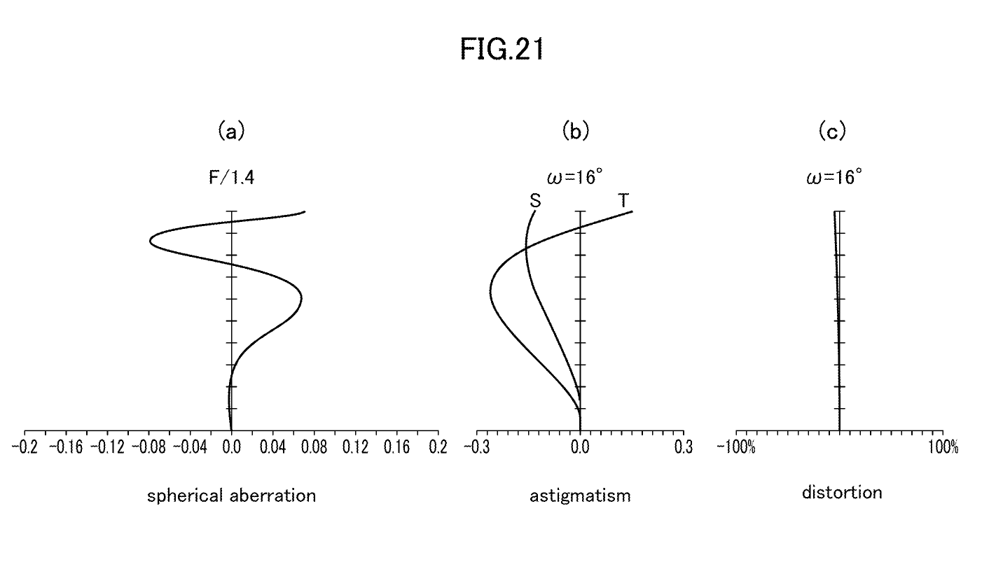

FIG. 22 is a vertical sectional view of an eighth embodiment of the infrared zoom lens according to the present invention, illustrating groups of lens pieces displaced from their respective infinity focus positions to the wide angle end positions;

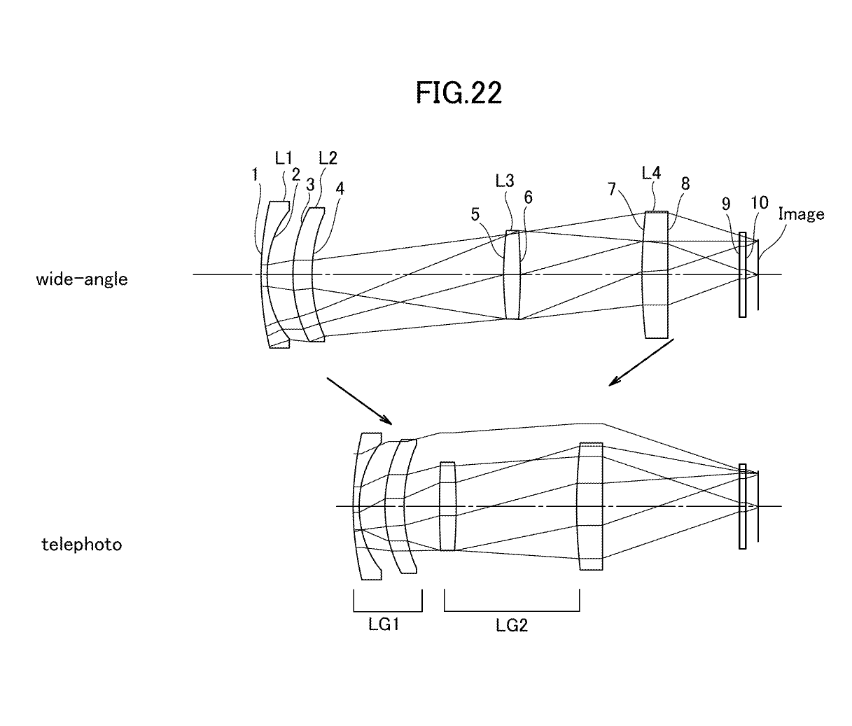

FIG. 23 depicts graphs of various types of aberration developed in the eighth embodiment of the infrared zoom lens in infinity focus at wide-angle end regarding beams of wavelength of 10 μm, including the graphs of spherical aberration (a), astigmatism (b), and distortion (c); and

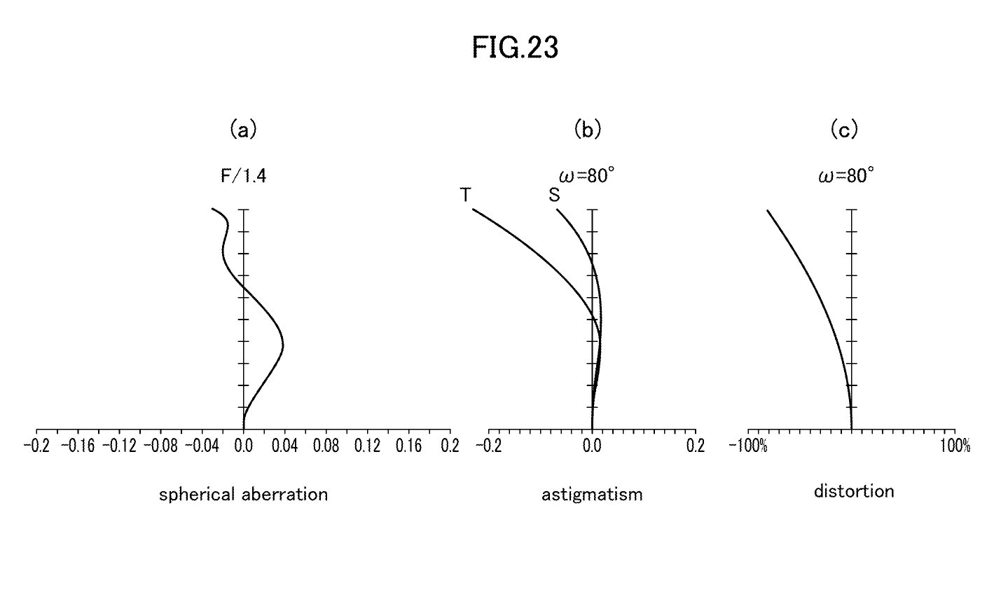

FIG. 24 depicts graphs of various types of aberration developed in the eighth embodiment of the infrared zoom lens in infinity focus at telephotographing end regarding beams of wavelength of 10 μm, including the graphs of spherical aberration (a), astigmatism (b), and distortion (c).

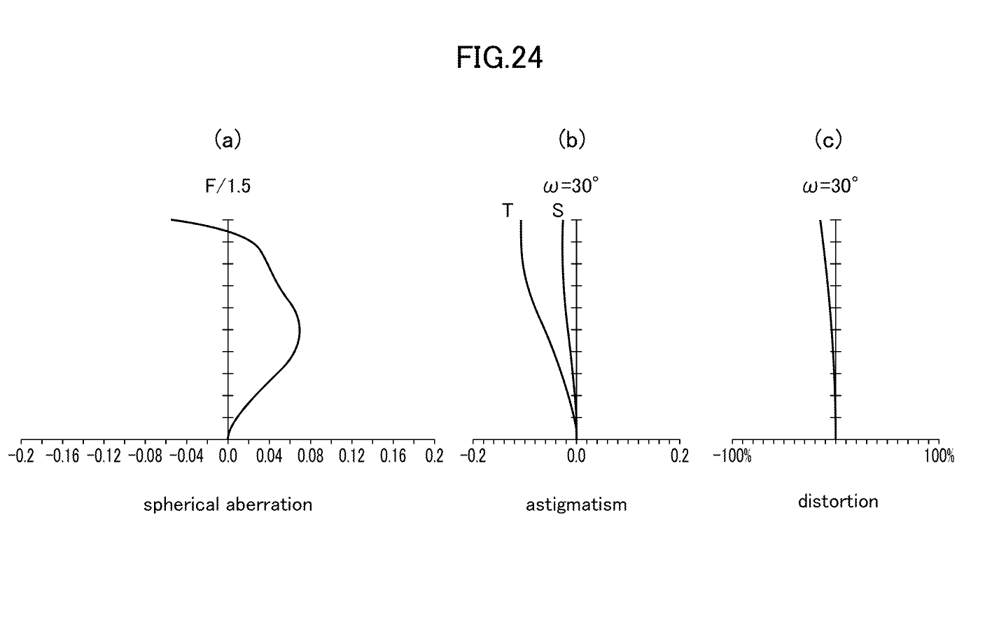

### DETAILED DESCRIPTION OF THE PREFERRED EMBODIMENT

In the following tables in conjunction with the various embodiments of the infrared zoom lens, Fno. denotes F number, and f denotes a focal length (in millimeters) of the entire lens system. NS, R, and D designate a number of a lens surface, a radius of curvature (in millimeters), and a thicknesswise dimension (in millimeters) of a lens piece or a distance between adjacent lens pieces, respectively, while GLASS denotes a lens material. A planar plate with the opposite surfaces in parallel with each other, which is positioned right in front of the imaging plane, is a cover glass for a photo detector presumptively employed. In any embodiment of which coverage angle of field is as wide as 180° or even greater, the developed distortion is shown by an amount of deviation from f−θ. The distance between adjacent lens pieces varied as the focal length is varied is denoted by D(i) of which exemplary values are shown in a different table. Asterisk * preceding a number of a lens surface refers to a lens surface in which an aperture stop is to be positioned.

ASPH succeeding a number of a lens surface shows that the surface is aspheric. An aspheric surface is given by a mathematical expression as follows:

$$X = \frac{{H}^{2} / R}{1 + \sqrt{1 - ( ɛ {H}^{2} / {R}^{2} )}} + {AH}^{2} + {BH}^{4} + {CH}^{6} + {DH}^{8} + {EH}^{10}$$

In the above mathematical expression, H designates a height (in millimeters) orthogonal to the optical axis. A displacement (in millimeters) from the apex of the lens surface, namely, the origin of coordinate axes or the height H and the optical axis is designated by X(H), R is a paraxial radius of curvature (in millimeters), and e is a constant of the cone. A, B, C, D, and E respectively denote constants of quadric, quartic, sextic, octavic, and decimic aspherical surfaces.

### Embodiment 1

| | Wide Angle | Telephoto |
|---|---|---|
| f | 5.5074 | 10.9999 |
| FNo. | 1.0 | 1.0 |
| Angle of Field (°) | 146 | 58 |

| NS | R | D | GLASS |
|---|---|---|---|
| 1 | 162.5508 | 2.0000 | Germanium |
| 2 | 28.1248 | 2.8194 | |
| 3 | 50.8843 | 3.0000 | Germanium |
| 4 | 96.9194 | D(4) | |
| *5 ASPH | −37.7097 | 2.5000 | Germanium |
| 6 ASPH | −28.2894 | 17.1482 | |
| 7 | −353.9810 | 4.0000 | Germanium |
| 8 ASPH | −46.9963 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 5 | 1.0000 | 0.00000E+000 | −1.31301E−005 | −4.95816E−008 | 1.90202E−009 | 1.03297E−011 |
| 6 | 1.0000 | 0.00000E+000 | −2.91225E−006 | 3.58006E−008 | −6.19449E−011 | 1.61329E−011 |
| 8 | 1.0000 | 0.00000E+000 | 6.89731E−006 | −5.32536E−008 | 3.79466E−010 | −1.07892E−012 |

| | Wide Angle | Telephoto |
|---|---|---|
| D(4) | 34.5340 | 5.0410 |
| D(8) | 11.0000 | 16.0177 |
| D(10) | 1.9995 | 1.9995 |

### Embodiment 2

| | Wide Angle | Telephoto |
|---|---|---|
| F | 4.5044 | 11.9999 |
| FNo. | 1.2 | 1.7 |
| Angle of Field (°) | 190 | 54 |

| NS | R | D | GLASS |
|---|---|---|---|
| 1 | 36.1370 | 2.0000 | Germanium |
| 2 | 16.4875 | 5.0008 | |
| 3 | 21.8759 | 2.0000 | Germanium |
| 4 | 23.5100 | D(4) | |
| *5 | 34.5500 | 2.5000 | Germanium |
| 6 ASPH | 73.2352 | 8.2976 | |
| 7 ASPH | −329.4570 | 4.0000 | Germanium |
| 8 ASPH | −78.7309 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 2 | 1.0000 | 0.00000E+000 | −2.07909E−006 | 1.62482E−007 | −1.06700E−009 | 3.15449E−012 |
| 6 | 1.0000 | 0.00000E+000 | 1.08902E−005 | −4.80838E−008 | 1.36305E−009 | −7.93994E−012 |
| 7 | 1.0000 | 0.00000E+000 | 1.07072E−004 | −1.43425E−007 | 9.51005E−009 | −4.25566E−011 |
| 8 | 1.0000 | 0.00000E+000 | 1.09477E−004 | 1.70298E−007 | 3.26594E−009 | 1..27227E−010 |

| | Wide Angle | Telephoto |
|---|---|---|
| D(4) | 42.2370 | 11.1110 |
| D(8) | 11.0000 | 19.5834 |
| D(10) | 1.9720 | 1.9720 |

### Embodiment 3

| | Wide Angle | Telephoto |
|---|---|---|
| F | 7.0106 | 20.9993 |
| FNo. | 1.2 | 1.7 |
| Angle of Field (°) | 104 | 30 |

| NS | R | D | GLASS |
|---|---|---|---|
| 1 | 143.0013 | 1.5000 | Germanium |
| 2 | 32.5747 | 3.0000 | |
| 3 | 30.8757 | 2.5000 | Germanium |
| 4 ASPH | 38.9080 | D(4) | |
| *5 ASPH | 19.7913 | 3.0000 | Germanium |
| 6 ASPH | 24.1278 | 10.9378 | |
| 7 ASPH | −64.7398 | 2.5000 | Germanium |
| 8 ASPH | −37.3774 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 4 | 1.0000 | 0.00000E+000 | 2.39765E−006 | 2.37825E−008 | −1.41078E−010 | 2.94597E−013 |
| 5 | 1.0000 | 0.00000E+000 | 1.09338E−005 | 2.29118E−007 | −3.26433E−010 | −2.85914E−012 |
| 6 | 1.0000 | 0.00000E+000 | 2.19315E−005 | 4.79524E−007 | −1.70015E−009 | −6.41008E−012 |
| 7 | 1.0000 | 0.00000E+000 | −1.25282E−004 | −4.32237E−007 | −2.02475E−009 | −7.77287E−011 |
| 8 | 1.0000 | 0.00000E+000 | −9.50643E−005 | −1.92544E−007 | −2.19929E−009 | −6.52491E−012 |

| | Wide Angle | Telephoto |
|---|---|---|
| D(4) | 42.5890 | 3.4440 |
| D(8) | 11.0000 | 22.1919 |
| D(10) | 1.9773 | 1.9773 |

### Embodiment 4

| | Wide Angle | Telephoto |
|---|---|---|
| F | 5.5060 | 10.9997 |
| FNo. | 1.4 | 1.4 |
| Angle of Field (°) | 146 | 60 |

| NS | R | D | GLASS |
|---|---|---|---|
| 1 | 200.7370 | 1.0000 | Germanium |
| 2 | 27.9422 | 4.2081 | |
| 3 | 56.2050 | 3.0000 | Germanium |
| 4 | 89.8444 | D(4) | |
| *5 ASPH | −635.4664 | 2.5000 | Germanium |
| 6 | −76.4709 | 18.1128 | |
| 7 | 253.4195 | 4.0000 | Germanium |
| 8 ASPH | −76.4490 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 5 | 1.0000 | 0.00000E+000 | −7.55292E−006 | 1.49663E−007 | −4.00515E−009 | 3.70662E−011 |
| 8 | 1.0000 | 0.00000E+000 | 3.72934E−006 | −1.75917E−009 | −3.20212E−011 | 1.56511E−013 |

| | Wide Angle | Telephoto |
|---|---|---|
| D(4) | 32.1410 | 5.4290 |
| D(8) | 10.9999 | 17.8156 |
| D(10) | 2.0000 | 2.0000 |

### Embodiment 5

| | Wide Angle | Telephoto |
|---|---|---|
| F | 5.5070 | 10.9994 |
| FNo. | 1.0 | 1.0 |
| Angle of Field (°) | 146 | 58 |

| NS | R | D | GLASS |
|---|---|---|---|
| 1 | 229.4636 | 2.0000 | Germanium |
| 2 | 35.7619 | 3.1848 | |
| 3 | 73.5234 | 3.0000 | Germanium |
| 4 | 187.4687 | D(4) | |
| *5 ASPH | −36.8198 | 2.5000 | Germanium |
| 6 ASPH | −26.5203 | 15.4371 | |
| 7 | −930.2530 | 4.0000 | Germanium |
| 8 ASPH | −46.6001 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 5 | 1.0000 | 0.00000E+000 | −6.94878E−005 | −3.99514E−007 | −2.02256E−009 | 2.43787E−011 |
| 6 | 1.0000 | 0.00000E+000 | −4.26129E−005 | −3.01663E−007 | −2.45685E−010 | 9.68178E−012 |
| 8 | 1.0000 | 0.00000E+000 | 1.16738E−005 | −1.02902E−007 | 7.94815E−010 | −2.51861E−012 |

| | Wide Angle | Telephoto |
|---|---|---|
| D(4) | 38.8450 | 3.8060 |
| D(8) | 8.0000 | 11.4600 |
| D(10) | 2.0340 | 2.0340 |

### Embodiment 6

| | Wide Angle | Telephoto |
|---|---|---|
| F | 4.5050 | 11.9996 |
| FNo. | 1.2 | 1.6 |
| Angle of Field (°) | 190 | 54 |

| NS | R | D | GLASS |
|---|---|---|---|
| 1 | 37.0677 | 2.0000 | Germanium |
| 2 ASPH | 16.8887 | 5.0006 | |
| 3 | 23.4742 | 2.0000 | Germanium |
| 4 | 25.8430 | D(4) | |
| *5 | 24.8626 | 2.5000 | Germanium |
| 6 ASPH | 41.5166 | 9.8931 | |
| 7 ASPH | −697.0557 | 4.0000 | Germanium |
| 8 ASPH | −97.4120 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 CD) | 10 (E) |
|---|---|---|---|---|---|---|
| 2 | 1.0000 | 0.00000E+000 | −1.91292E−007 | 8.91946E−008 | −4.29943E−010 | 1.27474E−012 |
| 6 | 1.0000 | 0.00000E+000 | 4.89455E−006 | −7.23323E−009 | −1.49249E−011 | 1.22840E−012 |
| 7 | 1.0000 | 0.00000E+000 | −2.60083E−005 | 9.56299E−007 | −5.69716E−009 | 4.78867E−011 |
| 8 | 1.0000 | 0.00000E+000 | −6.38192E−006 | 1.09865E−006 | −9.28422E−009 | 1.14686E−010 |

| | Wide Angle | Telephoto |
|---|---|---|
| D(4) | 43.5830 | 11.0020 |
| D(8) | 8.0308 | 16.1435 |
| D(10) | 1.9999 | 1.9999 |

### Embodiment 7

| | Wide Angle | Telephoto |
|---|---|---|
| F | 7.0092 | 20.9997 |
| FNo. | 1.3 | 1.4 |
| Angle of Field (°) | 104 | 32 |

| NS | R | D | GLASS |
|---|---|---|---|
| 1 | 71.0883 | 1.5000 | Germanium |
| 2 | 28.3927 | 3.0000 | |
| 3 | 26.2571 | 2.5000 | Germanium |
| 4 ASPH | 31.4858 | D(4) | |
| *5 ASPH | 16.6405 | 3.0000 | Germanium |
| 6 ASPH | 20.7421 | 10.3540 | |
| 7 ASPH | −53.8910 | 2.5000 | Germanium |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 4 | 1.0000 | 0.00000E+000 | 4.84784E−006 | −3.90181E−009 | 4.72695E−011 | −7.97898E−014 |
| 5 | 1.0000 | 0.00000E+000 | 8.80534E−006 | 2.59031E−007 | 8.66559E−011 | −1.60687E−012 |
| 6 | 1.0000 | 0.00000E+000 | 2.16902E−005 | 5.07503E−007 | −2.52777E−010 | −1.42451E−011 |
| 7 | 1.0000 | 0.00000E+000 | −3.13776E−004 | −5.16760E−007 | −9.64229E−009 | −4.21353E−010 |
| 8 | 1.0000 | 0.00000E+000 | −2.53740E−004 | 1.34165E−006 | −2.64797E−008 | 1.26948E−010 |

| | Wide Angle | Telephoto |
|---|---|---|
| D(4) | 47.8050 | 3.0170 |
| D(8) | 6.3440 | 14.5876 |
| D(10) | 2.0000 | 2.0000 |

### Embodiment 8

| | Wide Angle | Telephoto |
|---|---|---|
| f | 5.0069 | 10.9997 |
| FNo. | 1.4 | 1.5 |
| Angle of Field (°) | 160 | 60 |

| NS | R | D | GLASS |
|---|---|---|---|
| 1 | 57.4785 | 1.0000 | Germanium |
| 2 | 18.4108 | 3.8710 | |
| 3 | 24.6080 | 3.0000 | Germanium |
| 4 | 27.2874 | D(4) | |
| *5 ASPH | 172.2550 | 2.5000 | Germanium |
| 6 | −149.7565 | 18.7248 | |
| 7 | 82.2994 | 4.0000 | Germanium |
| 8 ASPH | −225.7916 | D(8) | |
| 9 | 0.0000 | 1.0000 | Germanium |
| 10 | 0.0000 | D(10) | |

| ASPH | 0 (EP) | 2 (A) | 4 (B) | 6 (C) | 8 (D) | 10 (E) |
|---|---|---|---|---|---|---|
| 2 | 1.0000 | 0.00000E+000 | 5.89403E−006 | −1.86961E−008 | 4.24634E−011 | 0.00000E+000 |
| 5 | 1.0000 | 0.00000E+000 | −6.30727E−006 | 1.40745E−007 | −2.92830E−009 | 2.10103E−011 |
| 8 | 1.0000 | 0.00000E+000 | 3.06141E−006 | 3.26661E−009 | −2.63159E−011 | 6.87028E−014 |

| | Wide Angle | Telephoto |
|---|---|---|
| D(4) | 29.9655 | 5.4243 |
| D(8) | 11.0000 | 21.1596 |
| D(10) | 1.9920 | 1.9920 |

Given below are the values of the terms f1/fw and f2/fw in the formulae in conjunction with the various embodiments according to the present invention:

| | f1/fw | f2/fw |
|---|---|---|
| Embodiment 1 | −3.43 | 3.13 |
| Embodiment 2 | −3.11 | 3.56 |
| Embodiment 3 | −3.24 | 2.59 |
| Embodiment 4 | −2.80 | 3.47 |
| Embodiment 5 | −4.50 | 2.83 |
| Embodiment 6 | −3.27 | 3.54 |
| Embodiment 7 | −4.03 | 2.38 |
| Embodiment 8 | −2.31 | 3.91 |

### DESCRIPTION OF THE ALPHANUMERIC REFERENCE SYMBOLS

| Image | Imaging Plane |
|---|---|
| LG1 | 1st Lens Group |
| LG2 | 2nd Lens Group |
| L1 | Front Lens Piece of the 1st Lens GP. |
| L2 | Rear Lens Piece of the 1st Lens GP. |
| L3 | Front Lens Piece of the 2nd Lens GP. |
| L4 | Rear Lens Piece of the 2nd Lens GP. |
| 1 | Lens Surface No. 1 |
| 2 | Lens Surface No. 2 |
| 3 | Lens Surface No. 3 |
| 4 | Lens Surface No. 4 |
| 5 | Lens Surface No. 5 |
| 6 | Lens Surface No. 6 |
| 7 | Lens Surface No. 7 |
| 8 | Lens Surface No. 8 |
| 9 | Lens Surface No. 9 |
| 10 | Lens Surface No. 10 |

1. An infrared zoom lens, comprising a front or first lens group of negative refractive power and a rear or second lens group of positive refractive power, and being adapted to axially displace the first and second lens groups during varying the refractive power,
each of the first and second lens groups being of two non-composite or non-cemented lens pieces.

2. The infrared zoom lens according to claim 1, wherein the infrared zoom lens meets the requirements defined as follows:
−4.7<f1/fw<−2.2 (1)
where f1 is a focal length of the first lens group, and fw is a focal length of the entire lens system at the wide viewing angle.

3. The infrared zoom lens according to claim 1, wherein the infrared zoom lens meets the requirements defined as follows:
2.0<f2/fw<4.0 (2)
where f2 is a focal length of the second lens group, and fw is a focal length of the entire lens system at the wide viewing angle.

4. The infrared zoom lens according to claim 1, wherein the first lens group comprises a negative meniscus lens closer to an object and a positive meniscus lens closer to an imaging plane.

5. The infrared zoom lens according to claim 1, wherein at least one of the lens pieces in the second lens group has its one or opposite sides shaped in aspheric surface.

6. The infrared zoom lens according to claim 1, wherein the lens pieces in both the first and second lens groups are made of germanium.
